(19) United States
(12) Patent Application Publication
(10) Pub. No.: US 2011/0191094 A1
(43) Pub. Date: Aug. 4, 2011

(54) SYSTEM AND METHOD TO EVALUATE AND SIZE RELATIVE SYSTEM PERFORMANCE

(76) Inventors: John Michael Quernermoen, New Brighton, MN (US); Mark G. Hazzard, Forest Lake, MN (US); Marwan A. Orfali, Woodbury, MN (US)

(21) Appl. No.: 12/696,420

(22) Filed: Jan. 29, 2010

(51) Int. Cl. G06F 17/00; G06F 15/00

(52) U.S. Cl. 703/21; 702/186

(57) ABSTRACT

A method and computer storage medium useable for estimating expected processor utilization for a workload on a computing system are disclosed. One method includes calculating an estimated throughput for a first computing system using a predetermined model based on physical characteristics of the first computing system. The method further includes determining an estimated utilization of the first computing system based on a utilization of a second computing system and a ratio of throughput of the second computing system to the estimated throughput of the first computing system.

### TECHNICAL FIELD

The present application generally relates to workload management for computing systems. The present application more specifically relates to methods and systems for evaluating and sizing relative system performance.

### BACKGROUND

In data centers or other server-based computing arrangements, a number of workloads are applied to a computing system, and are typically allocated to a computing system having available resources to commit to that workload. When determining whether a workload can be handled by a particular computing system, the system's capabilities are examined and compared to the known resource usage of the workload to determine if that system can handle the workload.

When servers or other computing systems in these environments are replaced, they are often replaced with newer systems having different computing capabilities. Workloads from deprecated systems are reallocated, or “migrated” to one of the remaining computing systems. To select the correct destination for the migrated workload, characteristics of the workload are analyzed. Workload characteristics include processor utilization, memory usage, disk traffic, mass storage (e.g., hard drive) space used, and network traffic. Additionally, processor-memory characteristics and hierarchy (e.g., bandwidth, latency, cache size/type, etc.) are considered for in both the source system and the target system to which the workload is to be migrated.

The relative performance of different computing systems is typically measured by benchmarks designed to test various aspects of a computing system (e.g., processing capabilities, memory capacity and bandwidth, disk I/O, etc.) However, benchmark data does not necessarily cover all systems that are surveyed as part of a system migration. When migrating workloads from/to systems for which no relative performance benchmark exists, it is difficult to determine whether the migration would be successful, or would over/underload the target system.

For these and other reasons, improvements are desirable.

### SUMMARY

In accordance with the following disclosure, the above and other problems are solved by the following:

In a first aspect, a method for estimating expected processor utilization for a workload on a computing system is disclosed. The method includes determining an estimated throughput for a first computing system using a predetermined model based on physical characteristics of the first computing system. The method farther includes determining an estimated utilization of the first computing system based on a utilization of a second computing system and a ratio of throughput of the second computing system to the estimated throughput of the first computing system.

In a second aspect, a method of migrating a workload from a source computing system to a target computing system is disclosed. The method includes determining resource utilization on the source computing system associated with a workload. The method also includes determining throughput for the workload on the source computing system. The method further includes calculating an estimated throughput for a target computing system using a predetermined model based on physical characteristics of the target computing system. The method also includes determining an estimated utilization of the target computing system based on a product of the resource utilization of the source computing system with a ratio of throughput of the source computing system to the estimated throughput of the target computing system.

In a third aspect, a computer-storage medium is disclosed. The computer-storage medium stores computer-executable instructions that, when executed on a computing system, cause the computing system to calculate an estimated throughput for a target computing system using a predetermined model based on physical characteristics of the target computing system. The instructions further cause the computing system to determine an estimated utilization of the target computing system based on a utilization of a source computing system and a ratio of throughput of the source computing system to the estimated throughput of the target computing system.

In a further aspect, a method of estimating performance of a computing system is disclosed. The method includes deriving a model of computing system performance that is a product of powers of physical characteristics of a computing system and derived from physical characteristics and measured performance of a plurality of computing systems having analogous system architectures. The method further includes obtaining an estimated performance of a computing system based on the model and the physical characteristics of the computing system.

### BRIEF DESCRIPTION OF THE DRAWINGS

FIG. 1 is a logical diagram of a network in which aspects of the present disclosure can be implemented;

FIG. 2 is a diagram of an example system migration according to a possible embodiment of the present disclosure;

FIG. 3 is a block diagram illustrating example physical components of an electronic computing device useable to implement the various methods and systems described herein;

FIG. 4 is a flowchart of methods and systems for estimating expected processor utilization for a workload on a computing system, according to a possible embodiment of the present disclosure;

FIG. 5 is a flowchart of methods and systems for migrating a workload from a source computing system to a target computing system;

FIG. 6 illustrates a plurality of plotted charts showing percentage error in estimated throughput using different models on different computing system architectures;

FIG. 7 illustrates a plurality of bar graphs showing how frequently percentage error in predicting benchmark scores occur in the systems tested and described in connection with FIG. 6; and

FIG. 8 illustrates a plurality of bar graphs showing distribution of error percentiles in predicting benchmark scores among the systems considered in FIGS. 6-7.

### DETAILED DESCRIPTION

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

The logical operations of the various embodiments of the disclosure described herein are implemented as: (1) a sequence of computer implemented steps, operations, or procedures running on a programmable circuit within a computer, and/or (2) a sequence of computer implemented steps, operations, or procedures running on a programmable circuit within a directory system, database, or compiler.

In general the present disclosure relates to estimating expected processor utilization for a workload on a computing system. Such estimations can be useful, for example, in assigning a workload to a target computing system from a source computing system, such as when migrating workloads among computing systems. The methods and systems of the present disclosure generally assist in selecting a target computing system that can handle such workloads, even when some comparison of measured throughput is unavailable for the target computing system and the source computing system. In general, by estimating throughput of systems from physical attributes of those systems and using a ratio including an estimated throughput for the systems, a proper target computing system can be selected for migration of workloads.

In the context of the present disclosure, throughput for a system generally relates to the rate at which transactions can be processed or workloads can be completed. Throughput can include one or both of measured throughput or estimated throughput using the techniques described herein. Additionally, in certain instances, throughput is determined based on a highest-possible or highest-practicable throughput measure. Other measures of throughput or capacity can be determined using any analogous measure that represents a best achievable performance with respect to a given (e.g., common) workload; for purposes of the present disclosure, the term “throughput” is intended to reflect any such measures.

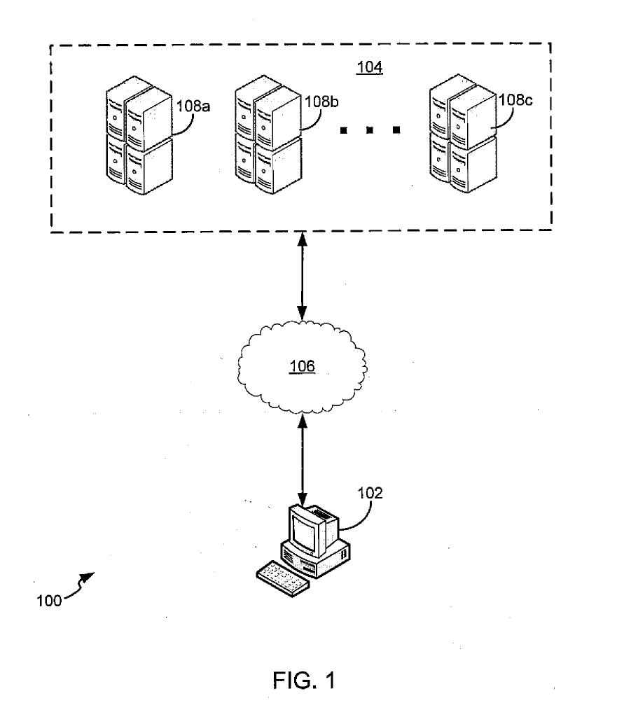

In general, FIGS. 1-3 of the present disclosure illustrate example systems and environments in which aspects of the present disclosure can be implemented. FIG. 1 is a logical diagram of an example network 100. The network 100 generally illustrates an arrangement for workload management and hosting, such as would be provided by a remote application provider, a web server, a remote processing/computing timeshare service, or other similar arrangement in which a number of server computing systems are used to execute discrete tasks, or workloads.

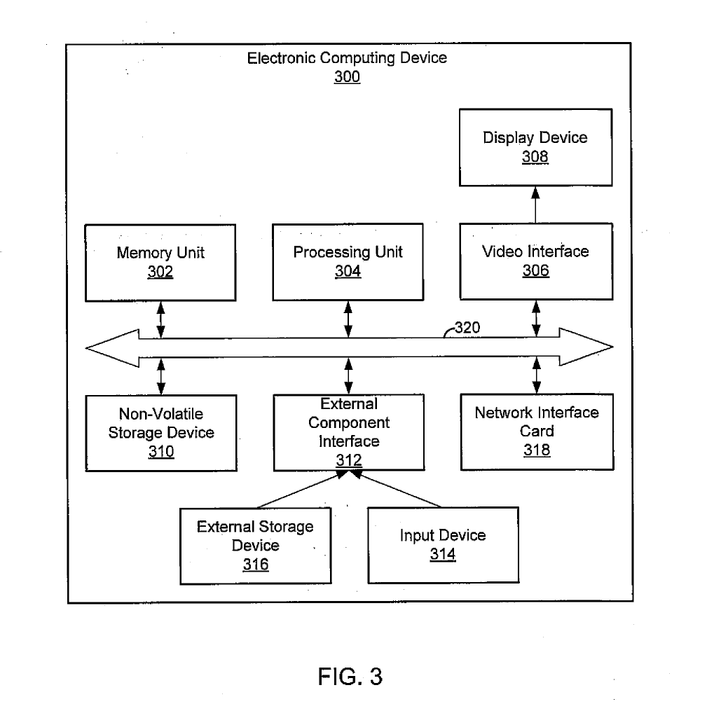

The network includes a computing device 102 connected to a computing center 104 via a network connection 106, such as the Internet or some other LAN, WAN, or other type of communicative connection. The computing device 102 can be any of a number of different types of devices, such as the computing device shown in FIG. 3, below. Likewise, the computing center 104 can include a number of computing devices of varying types, as described in connection with FIG. 3. In the embodiment shown, the computing center 104 includes a plurality of server devices 108a-c, each having differing computing capabilities. For example, each of the server devices 108a-c can have different types and numbers of processors, different memory bus speeds, different cache, RAM, and other memory capacities, different I/O and disk subsystem speeds and capacities, and other features.

The computing device 102 and computing center 104 can be used in a variety of contexts. For example, the computing center 104 can provide a variety of web services accessible to or controllable by the computing device 102, such that a variety of different web-based workloads are accessed from the computing center 104. In another example, the computing center 104 can host remote computing workloads scheduled either at the computing center 104 or the computing device, such as remote application hosting, database hosting, computing simulations, or other computationally-intensive workloads.

It is noted that, within the computing center 104, each server device 108a-c is capable of hosting one or more workloads or types of workloads, as each workload is typically independent of other workloads. Typically, each server device 108a-c can host a number of workloads before the hardware resources, of that device cannot timely execute the workload (e.g., due to insufficient or inadequate computational, memory, bandwidth, or other resources.

Additionally, it is noted that within the computing center 104 the server devices 108a-c are typically periodically upgraded, and therefore represent a heterogeneous set of computing systems. As each server device 108a-c is replaced, that replacement device will typically have a different set of physical computing characteristics. Therefore, as workloads are migrated from one device to another, different computing system utilization will be observed.

Although in the embodiment shown computing center 104 is illustrated as including three server devices 108a-c, it is understood that the computing center can include any of a number of server or other types of computing devices capable of executing the workloads under consideration. Furthermore, the various server devices can, in certain embodiments, represent physical computing systems or virtual computing systems hosted by such physical systems.

In the context of FIGS. 1-3, various types of processing and memory systems can be used in the computing device 102 or systems within computing center 104. In the context of the present disclosure, a processor, or processing “core”, typically refers to a central processing unit, and can be grouped with one or more other processors on a single die or within a single socketable component. Additionally, multiple sockets could be included in a single computing device, with each socket capable of receiving a component including one or more processors and associated cache memory. Additionally, within such a component or on such a die, one or more levels of cache memory can be included. This can include, for example, Level 1 (L1) cache, typically associated with each processor on a per-processor basis. The cache could also include Level 2 (L2) cache that may be associated separately with each processor, or may be associated with a group of processors. Additionally, the cache can include Level 3 (L3) cache, which is typically shared across a number of processors. Other cache schemes and hierarchies can be included as well.

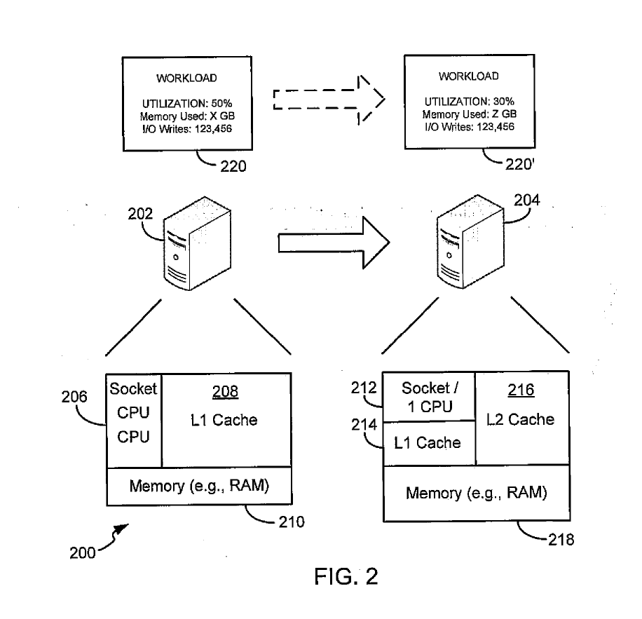

FIG. 2 is a diagram of an example system migration 200 according to a possible embodiment of the present disclosure. The system migration 200 illustrates two computing systems, including a source computing system 202 and a target computing system 204. Each of these computing systems has a plurality of operational characteristics, including those defined by particular physical characteristics. In the example shown, the source computing system 202 has a single socket 206 including a pair of processors, and an L1 cache 208 of a particular size. The source computing system 202 also has a memory subsystem 210, and a particular bandwidth for data sharing among each of these elements. The source computing system 202 also includes a number of other features, as explained below in connection with FIG. 3.

The target computing system 204, in the embodiment shown, has a single socket 212 hosting a single CPU, an L1 cache 214, and an L2 cache 216. The target computing system 204 also includes a memory subsystem 218, and a particular bandwidth for data sharing among these elements of the system.

Each of the components in the source computing system 202 and the target computing system 204 can vary as well, such that the source and target systems are essentially heterogeneous. For example, the CPUs in socket 206 of the source computing system 202 can operate at a different speed and have different instruction-level parallelism than the CPU in socket 212 of the target computing system 204. Additionally, the memory bandwidth and memory interface in each of these systems can differ, leading to vastly different performance results. However, in general, the source computing system 202 and the target computing system 204 have similar instruction set architectures such that they are each capable of hosting a workload without requiring that workload to be recompiled in a manner specific to that computing system. For example, both the source computing system 202 and the target computing system 204 can be any instruction set architecture, including x86, x86-64, or ARM architectures, IA64 (Itanium), SPARC, IBM P6 and other instruction set architectures.

In the system migration 200, a workload 220 is illustrated as executing on both the source computing system 202 and the target computing system 204. The workload 220 is illustrated as executing on each of those systems. As illustrated in this example, the workload 220 causes the source computing system 202 to operate using 50% CPU utilization, and X GB of memory (e.g., RAM, cache, etc.), while on the target computing system the workload (denoted as 220′) causes 30% CPU utilization with Z GB of memory used. In the example shown, I/O writes are the same (although this will typically not be the case, as a workload will typically have relatively constant disk traffic but will not be identical).

As shown in the above example, workloads remain substantially constant when migrated from one computing system (e.g., a source system 202) to another computing system (e.g., a target computing system 204). Specifically, a workload typically accomplishes the same amount of work in a given amount of time regardless of the system hosting the workload; although the amount of time it takes to complete workload tasks varies as a function of system characteristics, the overall rate at which workload tasks are input to the system is the same on both systems. Disk traffic, network traffic, storage, and memory used will be approximately the same. Therefore, with no workload growth, the workload will be accomplishing the same amount of work per unit of time (i.e., throughput) as it did on the source system: disk traffic, network traffic, mass storage used, and memory used will be approximately the same.

However, processor service time and I/O response time per unit of work could vary between the source computing system 202 and the target computing system 204 (illustrated by the CPU utilization indicated in FIG. 2). This can be for any of a variety of reasons. For example, faster disks and networking devices can reduce the number of each that are required. Additionally, a larger disk can also reduce the number of disks required. Calculations for memory capacity and disk and network device requirements on a computing system are relatively straightforward and are based on (1) performance characteristics and (2) load levels and capacity limits imposed to optimize response time. However, calculations for determining a necessary speed and throughput for processor and memory hierarchies are not straightforward.

Differences between the source computing system 202 and target computing system 204 (e.g., processor-memory characteristics, number of processors) change the amount of time spent by the processor and memory, and therefore change the service time per unit of work. Typically, this relationship is expressed as:

Throughput*Service Time=Utilization*Number of Processors

The relative performance of a number of computing systems with different processor-memory characteristics has been captured via benchmarks, which essentially represent “simulated” workloads that test particular features of a computing system. A common benchmark used to capture processor-memory characteristics is the SPEC (Standard Performance Evaluation Corporation) family of benchmarks. Certain benchmarks from among the group of benchmarks can be used to detect throughput for a computing system by testing the CPU, memory subsystem, disk subsystem, network connections and bandwidth therebetween. Having this benchmark information, relative service time can be estimated, and therefore system utilization can be estimated for a target computing system 204 prior to loading the workload onto that system, with a known utilization on the source computing system 202.

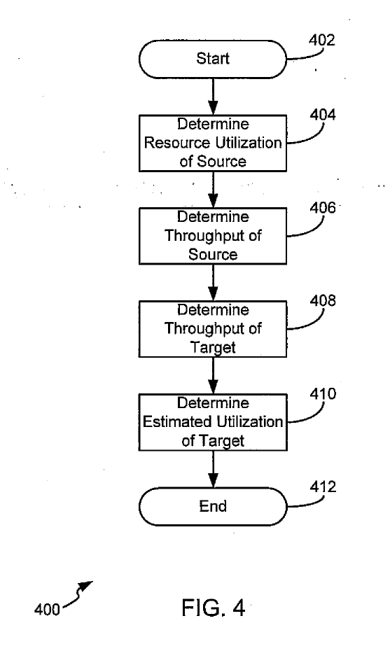

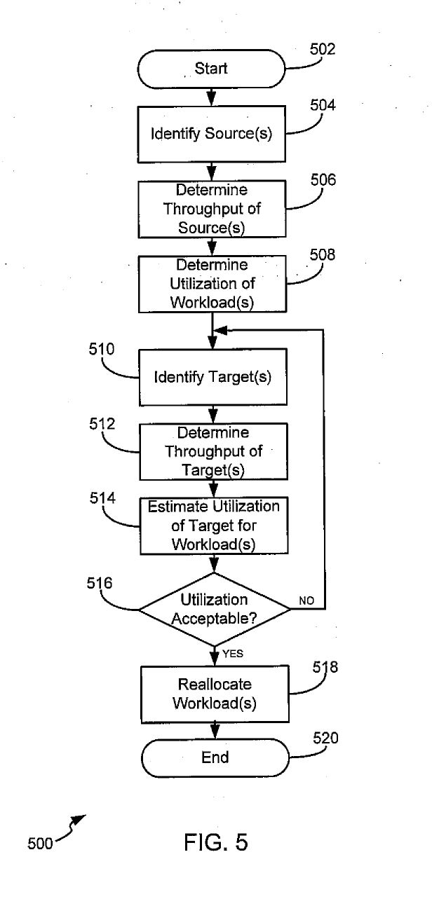

In certain embodiments of the present disclosure, benchmark data may be unavailable for use for at least one of the source computing system 202 and/or the target computing system 204. However, for the unknown system (either of system 202 or 204), the throughput, as measured by a common benchmark score, can be predicted or estimated using a model accounting for the physical differences between the computing systems. Using the estimated throughput, the system utilization can be estimated as well, to determine whether the target system is an appropriate location for execution of the workload. Example methods to estimate throughput and utilization of the target system are described below in conjunction with FIGS. 4-5.

FIG. 3 is a block diagram illustrating example physical components of an electronic computing device 300, which can be used to execute the various operations described above, and can be any of a number of the devices described in FIG. 1 and including any of a number of types of communication interfaces as described herein. A computing device, such as electronic computing device 300, typically includes at least some form of computer-readable media. Computer readable media can be any available media that can be accessed by the electronic computing device 300. By way of example, and not limitation, computer-readable media might comprise computer storage media and communication media.

As illustrated in the example of FIG. 3, electronic computing device 300 comprises a memory unit 302. Memory unit 302 is a computer-readable data storage medium capable of storing data and/or instructions. Memory unit 302 may be a variety of different types of computer-readable storage media including, but not limited to, dynamic random access memory (DRAM), double data rate synchronous dynamic random access memory (DDR SDRAM), reduced latency DRAM, DDR2 SDRAM, DDR3 SDRAM, Rambus RAM, or other types of computer-readable storage media.

In addition, electronic computing device 300 comprises a processing unit 304. As mentioned above, a processing unit is a set of one or more physical electronic integrated circuits that are capable of executing instructions. In a first example, processing unit 304 may execute software instructions that cause electronic computing device 300 to provide specific functionality. In this first example, processing unit 304 may be implemented as one or more processing cores and/or as one or more separate microprocessors. For instance, in this first example, processing unit 304 may be implemented as one or more Intel Core 2 microprocessors. Processing unit 304 may be capable of executing instructions in an instruction set, such as the x86 instruction set, the POWER instruction set, a RISC instruction set, the SPARC instruction set, the IA-64 instruction set, the MIPS instruction set, or another instruction set. In a second example, processing unit 304 may be implemented as an ASIC that provides specific functionality. In a third example, processing unit 304 may provide specific functionality by using an ASIC and by executing software instructions.

Electronic computing device 300 also comprises a video interface 306. Video interface 306 enables electronic computing device 300 to output video information to a display device 308. Display device 308 may be a variety of different types of display devices. For instance, display device 308 may be a cathode-ray tube display, an LCD display panel, a plasma screen display panel, a touch-sensitive display panel, a LED array, or another type of display device.

In addition, electronic computing device 300 includes a non-volatile storage device 310. Non-volatile storage device 310 is a computer-readable data storage medium that is capable of storing data and/or instructions. Non-volatile storage device 310 may be a variety of different types of non-volatile storage devices. For example, non-volatile storage device 310 may be one or more hard disk drives, magnetic tape drives, CD-ROM drives, DVD-ROM drives, Blu-Ray disc drives, or other types of non-volatile storage devices.

Electronic computing device 300 also includes an external component interface 312 that enables electronic computing device 300 to communicate with external components. As illustrated in the example of FIG. 3, external component interface 312 enables electronic computing device 300 to communicate with an input device 314 and an external storage device 316. In one implementation of electronic computing device 300, external component interface 312 is a Universal Serial Bus (USB) interface. In other implementations of electronic computing device 300, electronic computing device 300 may include another type of interface that enables electronic computing, device 300 to communicate with input devices and/or output devices. For instance, electronic computing device 300 may include a PS/2 interface. Input device 314 may be a variety of different types of devices including, but not limited to, keyboards, mice, trackballs, stylus input devices, touch pads, touch-sensitive display screens, or other types of input devices. External storage device 316 may be a variety of different types of computer-readable data storage media including magnetic tape, flash memory modules, magnetic disk drives, optical disc drives, and other computer-readable data storage media.

In the context of the electronic computing device 300, computer storage media includes volatile and nonvolatile, removable and non-removable media implemented in any method or technology for storage of information such as computer readable instructions, data structures, program modules or other data. Computer storage media includes, but is not limited to, various memory technologies listed above regarding memory unit 302, non-volatile storage device 310, or external storage device 316, as well as other RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the electronic computing device 300.

In addition, electronic computing device 300 includes a network, interface card 318 that enables electronic computing device 300 to send data to and receive data from an electronic communication network. Network interface card 318 may be a variety of different types of network interface. For example, network interface card 318 may be an Ethernet interface, a token-ring network interface, a fiber optic network interface, a wireless network interface (e.g., WiFi, WiMax, etc.), or another type of network interface.

Electronic computing device 300 also includes a communications medium 320. Communications medium 320 facilitates communication among the various components of electronic computing device 300. Communications medium 320 may comprise one or more different types of communications media including, but not limited to, a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computer System Interface (SCSI) interface, or another type of communications medium.

Communication media, such as communications medium 320, typically embodies computer-readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

Electronic computing device 300 includes several computer-readable data storage media (i.e., memory unit 302, non-volatile storage device 310, and external storage device 316). Together, these computer-readable storage media may constitute a single data storage system. As discussed above, a data storage system is a set of one or more computer-readable data storage mediums. This data storage system may store instructions executable by processing unit 304. Activities described in the above description may result from the execution of the instructions stored on this data storage system. Thus, when this description says that a particular logical module performs a particular activity, such a statement may be interpreted to mean that instructions of the logical module, when executed by processing unit 304, cause electronic computing device 300 to perform the activity. In other words, when this description says that a particular logical module performs a particular activity, a reader may interpret such a statement to mean that the instructions configure electronic computing device 300 such that electronic computing device 300 performs the particular activity.

One of ordinary skill in the art will recognize that additional components, peripheral devices, communications interconnections and similar additional functionality may also be included within the electronic computing device 300 without departing from the spirit and scope of the present invention as recited within the attached claims.

FIG. 4 is a flowchart of a method 400 for estimating expected processor utilization for a workload on a computing system, according to a possible embodiment of the present disclosure. The method 400 can be implemented in any of a number of manners, such as embodied in workload management software operating on a computing system such as any of those shown in FIGS. 1-3, above. The method 400 is instantiated at a start operation 402, which corresponds to initial consideration of workloads for migration between a source computing system (e.g., system 202) and target computing system (e.g., system 204).

A resource utilization determination module 404 determines the resource utilization of a first computing system, such as a source computing system. The resource utilization determination module 404 can obtain this information from any of a number of locations, such as from system usage logs, user entry, or other sources.

A throughput measurement module 406 determines the throughput of a source computing system. Throughput of the source computing system can be determined in any of a number of ways. Typically, the throughput measurement module 406 determines the throughput of the system as a numerical score derived from a benchmark executed on that computing system. Some examples of benchmarks useable to test throughput of a computing system are the SPECint2000, SPECint2006 benchmark suites. Other benchmarks can be used as well. A benchmark is selected for a number of reasons, including (1) the fact that there are a number of published results for various types of computing systems from which trends can be extrapolated, and (2) the benchmark typically operates at or near 100% processor busy, causing it to determine throughput by saturating the processing and memory bus capabilities.

In certain embodiments, such as those in which benchmark results for the source computing system are not readily available, the throughput measurement module 406 calculates an estimated throughput of the source computing system using an analogous methodology as set forth for the target computing system as described below.

A throughput calculation module 408 corresponds to calculation of throughput of the target computing system. The throughput calculation module 408 calculates a throughput of the target computing system (e.g., system 204). In certain embodiments, the throughput is represented as a numerical score placed on a scale analogous to that of the throughput of the source computing system, determined by the throughput measurement module.

In certain embodiments of the present disclosure, the throughput calculation module determines an estimated throughput for a computing system (e.g., the target computing system) from the following equation, representing a model of throughput in a computing system:

Throughput=A*nCpSE*nCore^{C}*SysBus^{D}*Cache^{E}*MHz^{F}

In this equation, the following variables are defined to represent physical characteristics of the computing system under consideration, as follows:

nCpS≡Number cores per processor

nCore≡Number cores

SysBus≡System Bus speed (MHz)

Cache≡Maximum Aggregate Size (e.g., L2 or L3 cache, in MB)

MHz≡Processor MHz

The other symbols, i.e., exponents, included in the above throughput model vary according to the instruction set architecture of the system under consideration. For certain example embodiments, the values for the constants included in this equation are listed in the below table for two instruction set architectures, an x86 architecture (e.g., using a microprocessor manufactured by Intel Corporation or Advanced Micro Devices) and an IA64 device using the Itanium 2 instruction set architecture:

| | | Value | |
|---|---|---|---|
| Constant | Description | Non-Itanium 2 | Itanium 2 |
| A | Constant Multiplier | 0.1323 | 0.0007 |
| B | Cores per Socket | −0.0634 | 0.1467 |
| C | Cores | 0.8029 | 0.9550 |
| D | System Bus Speed | 0.5389 | 0.3696 |
| E | Max of L2, L3 Cache Size | 0.2201 | 0.0805 |
| F | Processor MHz | 0.1598 | 1.0264 |

These numerical values derive from a regression analysis of a number of computing systems running the SPECint2000 rate benchmark to determine throughput for those systems. The results of that regression analysis correspond to the above throughput equation and values.

In alternative embodiments, fewer variables and fewer physical characteristics could be used to generate a model for estimating throughput of a system. In an alternative embodiment, a model can be derived using only the number of cores in a computing system and the processor speed for that system (i.e., nCore and MHz, above). Such a model could be represented as:

Throughput=A*(nCores*MHz)^{B}

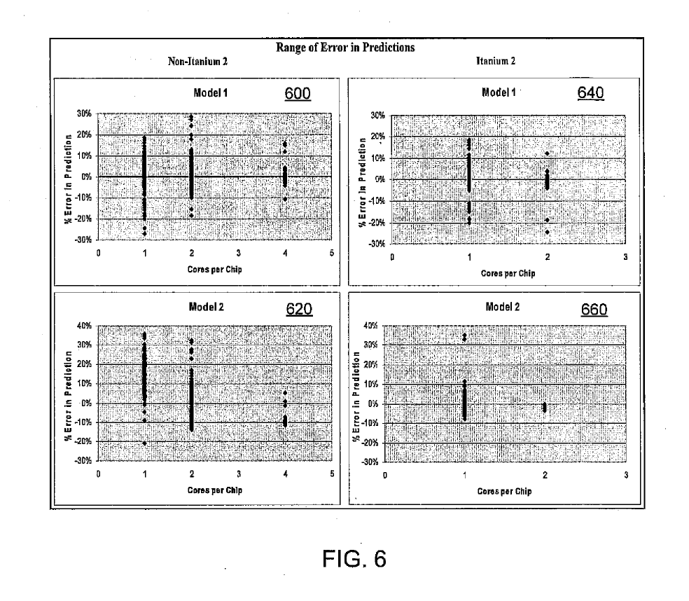

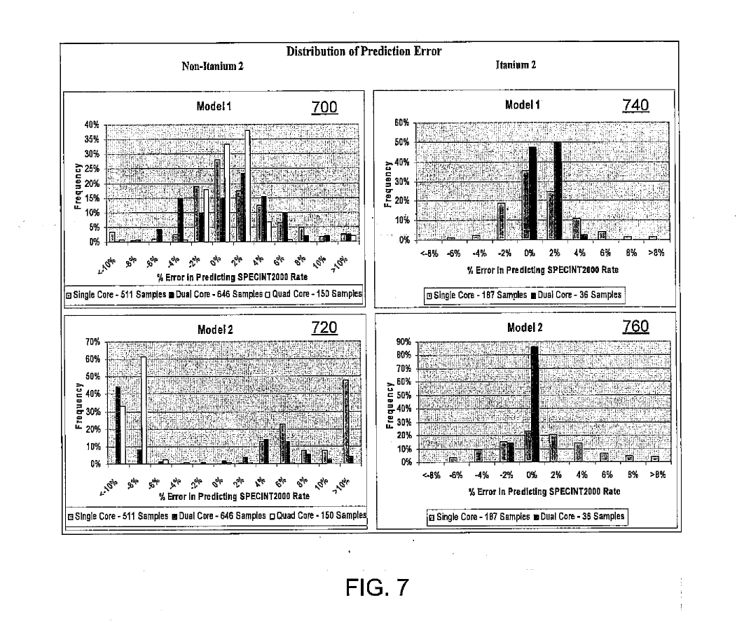

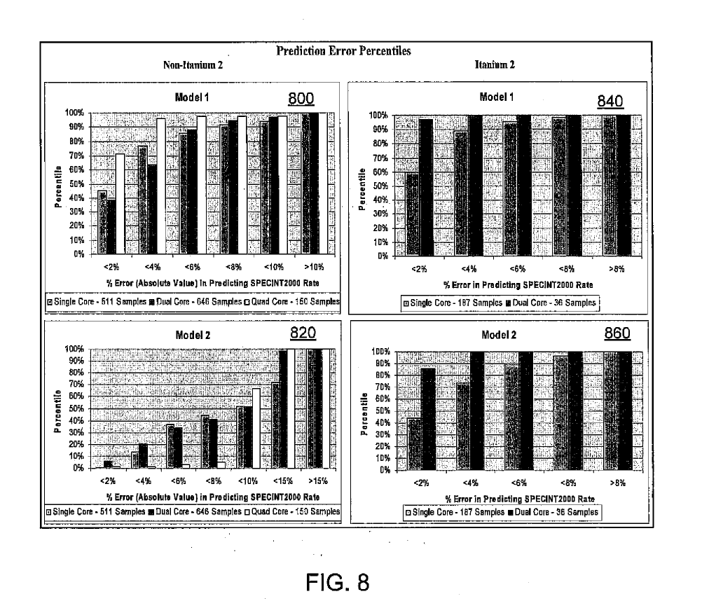

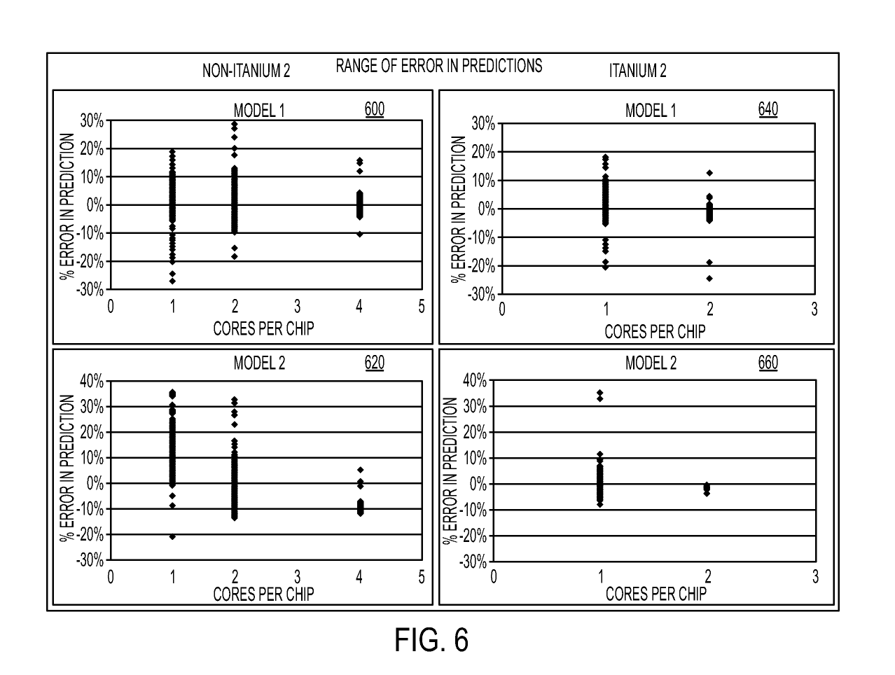

Such a model would provide increased simplicity due to the lower number of variables involved, but would introduce a greater amount of error between the estimated and actual throughput, as discussed below in connection with FIGS. 6-8. Other models, using other combinations of physical characteristics, could be used as well.

The utilization law is used to compare performance of the source and target systems to estimate utilization of the target system. The utilization law states:

Throughput*Service Time=Utilization*Number of Servers

Typically, as is the case with the SPECint2000 rate benchmark, benchmark tests cause CPUs of the systems under consideration to operate at or near 100% busy. Thus, we can use the above utilization law to compare service times of candidate systems. In the below models, the following values are represented:

| Variables | | Subscripts | |
|---|---|---|---|
| Acronym | Description | Acronym | Description |
| U | Utilization | O | Source System |
| S | Service Time | T | Target System |
| C | No. Cores, | B | SPECint2000_rate benchmark |
| | i.e., Servers | | result |
| H | No. Threads | M | Measurement on source system |
| X | Throughput | | |

Thus, when both source and target systems are running a benchmark at 100% busy, the ratio, R_{B}, of service times can be expressed as:

R_{B}=S_{TB}/S_{OB}=(C_{TB}/C_{OB})*(X_{OB}/X_{TB})

Estimating utilization on the target computing system further requires the following two assumptions: (1) The ratio of target to source service times when running a benchmark is the same as when miming a workload; (2) The throughput on the target system is the same as that on the source system when running the workload measured on the source system. In particular,

S_{TE}/S_{OE}=S_{TB}/S_{OB}

X_{OM}=X_{TE}

An estimated utilization module 410 determines estimated utilization of the target computing system (U_{TE}) based on the utilization of the source computing system (U_{OM}) and a ratio of the throughputs of the source computing system (X_{OB}) and the target computing system (X_{TB}). This determination is represented by the following model illustrating the correspondence of utilization of the source and target systems as relating to throughput, applying the above three formulas to determine estimated utilization of the target system:

U_{TE}=U_{OM}*(X_{OB}/X_{TB})

In certain circumstances, additional hardware features within a core can affect throughput and performance in a given system that are not reflected by a benchmark. In such cases, adjustment factors can be incorporated into the models described herein to allow tuning and adjustment of the above models. For example, certain types of microprocessor cores include “hyperthreading” features that allow the microprocessor to handle more than a single instruction sequence at a time. In such circumstances, the above utilization determination as provided by the estimated utilization module 410 can be adjusted by a ratio of adjustment factors ‘I’, which represents the extent to which these technologies are present and effect real-world (i.e., non-benchmark) throughput increases in the source and/or target systems:

U_{T}=U_{OM}*(X_{OB}/X_{TB})*(I_{O}/I_{T})

If no such adjustment is necessary for a computing system, the value is 1, but if some adjustment is included, that adjustment ‘I’ value would be some number greater than 1 depending upon the extent to which the hardware feature assists with throughput.

An end operation 412 corresponds to completed estimation, and optionally communication to a user of the method of an indication as to whether the target computing system could support the workload, or of the estimated system utilization of the target system.

Within the method 400, additional features can be included to determine the estimated throughput or utilization of a target system, for example in the case where the method is used to migrate a workload to a virtual computing system as the target computing system.

FIG. 5 is a flowchart of a method 500 for migrating a workload from one or more source computing systems to one or more target computing systems, using the methods, systems, and models described herein. The method 500 is instantiated at a start operation 502, which corresponds to initial consideration of migrating workloads among systems at a computing center (e.g., center 104 of FIG. 1).

A source identification module 504 corresponds to identifying one or more source computing systems (e.g., systems 202) on which one or more workloads is executed. The identification module 504 also optionally includes collecting information about those source systems, including various hardware or physical characteristics of the source systems. The physical characteristics can include any of the previously mentioned characteristics relevant to throughput, such as the number of processor cores, number of cores per processor, system bus speed, maximum cache size, and processor clock speed. Other features or characteristics could be tracked as well. The optional collection of information can be for tracking purposes, or for estimating throughput according to the principles described above with respect to FIGS. 2 and 4.

A source throughput module 506 determines throughput for each of the selected source systems identified by the source identification module 504. The source throughput module 506 can operate in a number of different ways. In certain embodiments, the source throughput module 506 obtains source throughput in the form of benchmark scores previously recorded, e.g., in a lookup table. In other embodiments, the source throughput module 506 calculates an estimated throughput from the physical characteristics of each source computing system having a workload under consideration for migration, as described above with respect to FIG. 4. In a further alternative, the source throughput module 506 can determine source throughput by running a benchmark on the selected source computing systems. Other possibilities exist as well.

A source utilization module 508 determines the utilization of the sources selected by the source identification module 504. In some embodiments, the source utilization module 508 can collect source computing system utilizations for workloads from logs or other indicators (e.g., monitoring applications) on a source computing system.

A target identification module 510 identifies one or more target computing systems (e.g., systems 204) to which one or more workloads may be migrated. The target identification module 510 collects information about physical characteristics of the one or more selected target computing systems to be used with those workloads. The characteristics can be any of a number of characteristics noted above with respect to the source computing systems.

A target throughput module 512 determines throughput for each of the selected target systems identified by the target identification module 510. The target throughput module 512 determines throughput of the target computing system(s) by calculating an estimated throughput of the target computing systems using the collected physical characteristics using one or more models disclosed herein, in particular in connection with FIGS. 2 and 4. In alternative embodiments, the target throughput module 512 can determine throughput using any of the methods described above with respect to the source throughput module 506; in such embodiments, the source and target throughput need not be determined using the same methodology, so long as the same type of measurement or scaling (e.g., the same benchmark) is used.

A target utilization module 514 computes the estimated utilization of the target computing system based on a product of the resource utilization of the source computing system with a ratio of throughput of the source computing system to the estimated throughput of the target computing system, also as described above.

An assessment module 516 determines whether the selected target computing system(s) can support the workloads selected from the source computing systems. This can be performed any of a number of ways. For example, the assessment module 516 can be configured to determine whether the computed utilization of the selected target computing system(s) can be held below a threshold level under which it would be unlikely to saturate the target system. If multiple workloads are under consideration, each of those workloads could be considered separately and assigned to a different target computing system, thereby spreading migrated workloads across multiple target computing systems. If the assessment module determines that the target systems cannot handle the workloads to be migrated, operational flow branches “no” to the target identification module 510 to select a different set of target systems to support the workload to be migrated. Optionally, operational flow could alternatively branch to the source identification module 504 to identify new sources and new workflows for migration.

If the assessment module determines that the target computing systems can handle the workloads to be migrated, operational flow branches “yes” to the reallocation module. The reallocation module 518 reassigns the selected workloads from the source computing systems to the target computing systems. An end operation 520 signifies a completed migration operation at the computing center.

Referring now to FIGS. 6-8, various graphs of test results illustrating the typical amount of error in the predicted throughput methodology described herein are shown. Each of FIGS. 6-8 illustrate error rates comparing actual throughput results (determined by measured SPECint2000 rate results) to the results determined from calculations as set forth above. In each of FIGS. 6-8, two models and two instruction set architectures are considered, resulting in four separate charts per figure. The two models, labeled “Model 1” and Model 2”, correspond to the throughput models described above with respect to FIG. 4. Specifically, Model 1 corresponds to the throughput model:

Throughput=A*nCpS^{B}*nCore^{C}*SysBus^{D}*Cache^{E}*MHz^{F}

Model 2 therefore corresponds to the throughput model:

Throughput=A*(nCores*MHz)^{B}

The two instruction set architectures correspond to an Intel x86 architecture and an IA 64 (“Itanium 2”) architecture.

FIG. 6 illustrates four plotted charts showing percentage error in estimated throughput using different models on different computing system architectures. These charts specifically illustrate error in the calculated rates compared to the measured values. FIG. 6 shows the range of prediction errors (Predicted Value/Measured Value−1) for the two models and for the two general types of processors.

As shown in FIG. 6, chart 600 represents the error distribution for Model 1 for the x86 architecture, and chart 620 represents Model 2 for the x86 architecture. Similarly, chart 640 represents the error distribution for Model 1 for the IA64 architecture and chart 660 represents the error distribution for Model 2 for the IA64 architecture. In these charts, prediction errors are shown as a function of cores per chip. For the non-Itanium 2 case, Model 1 (chart 600) has prediction errors somewhat uniformly distributed about the origin whereas Model 2 (chart 620) has errors weighted more positive and somewhat larger for Single core, less so for Dual core, and more uniform for quad core. For the Itanium 2 case, the distributions are more similar for the two models; however, Model 2 (chart 660) shows a slightly positive skew.

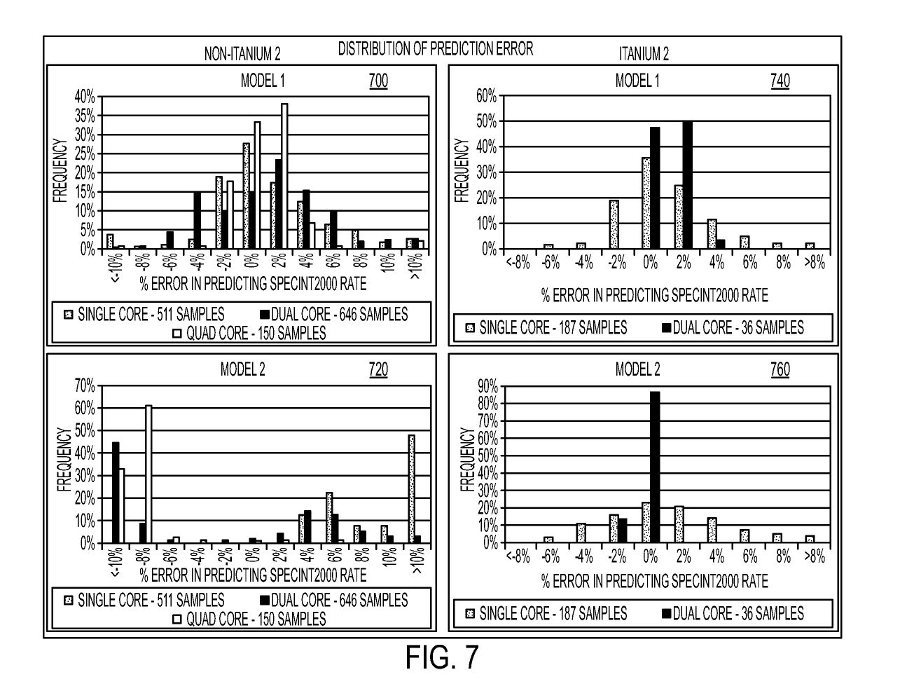

FIG. 7 illustrates four bar graphs showing how frequently percentage error in predicting benchmark scores occur in the systems tested and described in connection with FIG. 6. In FIG. 7, chart 700 represents the distribution of prediction error for Model 1 on an x86 architecture, and chart 720 represents the distribution of prediction error for Model 2 on the same architecture. Similarly, chart 740 represents a distribution of prediction error for Model 1 on an IA64 architecture, and chart 760 represents the distribution of prediction error for Model 2 on that architecture.

As illustrated among the charts in FIG. 7, the skew in distribution is apparent. Specifically, for the non-Itanium 2 case, errors in Model 1 are normally distributed around the origin with most between −8% and +8% (see chart 700). In contrast, for model 2, the distributions are skewed below −8% and above +4% (see chart 720). For the Itanium 2 case, both models exhibit similar behavior (see charts 740, 760).

It is observed from FIG. 7 that, at least for the non-Itanium 2 case, Model 2 is optimistic in its predictions for single core systems, unpredictable for dual core systems, and pessimistic for quad core systems. In contrast, Model 1 has relatively small errors (<8%) around the origin.

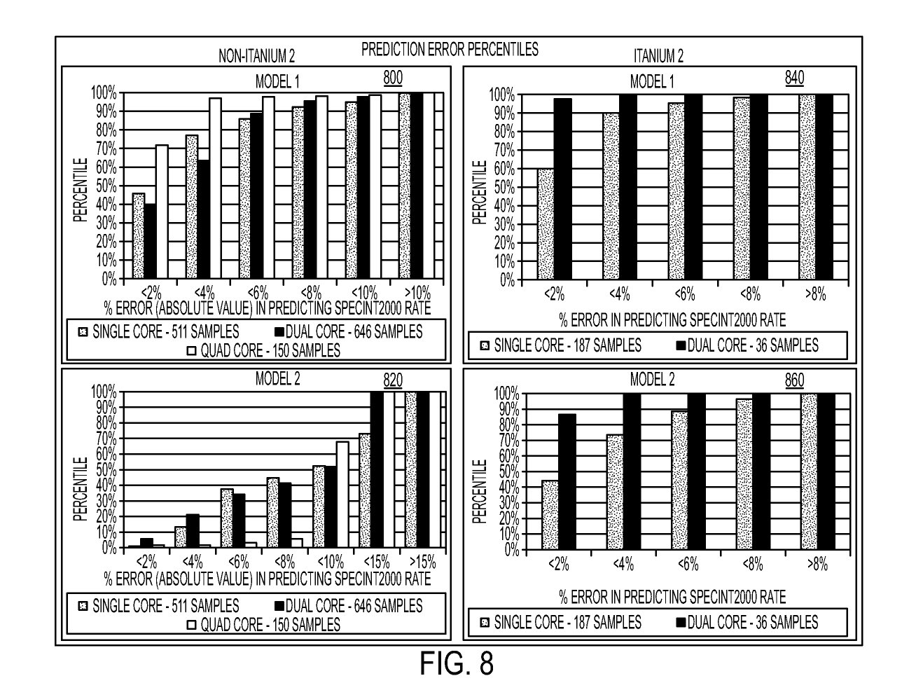

FIG. 8 illustrates a set of four bar graphs showing distribution of error percentiles in predicting benchmark scores among the systems considered in FIGS. 6-7. For the non-Itanium 2 case, 90% or more of Model 1's predictions have an error (absolute value) of less than 8% (chart 800). In contrast, Model 2's 90th percentile of errors is achieved in the range ±15% (chart 820). For the Itanium 2 case, the 90th percentile is achieved between 4 and 6% for Model 1 (chart 840), and between 6 and 8% for Model 2 (chart 860).

Although the example models described relate to a particular measured representation of system throughput (SPECint2000_rate), other tests or benchmarks could be used as well. For example, as additional SPEC benchmarks are published that test throughput at the processor and memory subsystem, those benchmark results could be used to derive a similar model using that different “simulated” workload. Derived models from benchmark or other test results improve in accuracy with a greater number of data points from which to derive a correlation; therefore, a large number of test results for a given test will result in improved accuracy in predicting utilization for the purposes of migrating workloads or determining other types of performance estimates.

Additionally, the examples provided above provide advantages even in cases where published performance results are available. For example, the methods and systems described in the present application can be used to estimate throughput score and relative service time, thus eliminating or reducing the time or effort required to maintain a database or table of published results, regardless of whether the lookup is performed manually or as a part of an automated process.

Furthermore, it is recognized that the scaling concepts of the present disclosure can be applied to a number of different contexts, including scaling of theoretical computing devices as well as physical computing devices, for migration, sizing, architectural feature planning to achieve a desired performance, or other purposes.

The above specification, examples and data provide a complete description of the manufacture and use of the composition of the invention. Since many embodiments of the invention can be made without departing from the spirit and scope of the invention, the invention resides in the claims hereinafter appended.

1. A method of estimating expected processor utilization for a workload on a computing system, the method comprising:
determining an estimated throughput for a first computing system using a predetermined model based on physical characteristics of the first computing system; and
determining an estimated utilization of the first computing system based on a utilization of a second computing system and a ratio of a throughput of the second computing system to the estimated throughput of the first computing system.

2. The method of claim 1, wherein the utilization of the second computing system is measured with the workload executing on the second computing system.

3. The method of claim 1, wherein the first computing system is a target computing system and the second computing system is a source computing system.

4. The method of claim 1, further comprising measuring throughput for the second computing system.

5. The method of claim 1, wherein throughput of the second computing system is measured using a benchmark.

6. The method of claim 5, wherein the estimated throughput of the first computing system is an estimated benchmark score.

7. The method of claim 1, wherein the throughput of the second computing system is an estimated benchmark score determined using a predetermined model based on physical characteristics of the second computing system.

8. The method of claim 1, wherein the physical characteristics include one or more characteristics selected from the group consisting of:
number of processor cores;
number of cores per processor;
system bus speed;
maximum cache size; and
processor clock speed.

9. The method of claim 1, wherein the predetermined model is a product of values derived from physical characteristics of the first computing system.

10. The method of claim 9, wherein the predetermined model is a product of powers derived from physical characteristics of the first computing system.

11. The method of claim 1, wherein calculating an estimated throughput for a first computing system includes calculating a product of values derived from the physical characteristics of the first computing system.

12. The method of claim 11, wherein the values are further derived from regression analysis of the physical characteristics of a plurality of computing systems.

13. The method of claim 1, wherein the predetermined model is developed from benchmark results on computing systems having similar instruction set architectures.

14. The method of claim 1, wherein the estimated utilization is further determined based on a ratio of increase factors associated with the first and the second computing systems.

15. A method of migrating a workload from a source computing system to a target computing system, the method comprising:
determining resource utilization on the source computing system associated with a workload;
determining throughput for the workload on the source computing system;
calculating an estimated throughput for a target computing system using a predetermined model based on physical characteristics of the target computing system;
determining an estimated utilization of the target computing system based on a product of the resource utilization of the source computing system with a ratio of throughput of the source computing system to the estimated throughput of the target computing system.

16. The method of claim 15, further comprising assigning the workload to the target computing system based on the estimated utilization.

17. The method of claim 15, wherein throughput of the second computing system is measured using a benchmark.

18. The method of claim 15, wherein the estimated utilization is further determined based on a ratio of increase factors associated with the target computing system and the source computing system.

19. The method of claim 15, wherein the estimated throughput of the target computing system is an estimated benchmark score.

20. The method of claim 15, wherein calculating an estimated throughput for a first computing system includes calculating a product of values derived from the physical characteristics of the first computing system.

21. The method of claim 15, wherein determining throughput for the workload on the source computing system includes calculating an estimated throughput for the source computing system.

22. The method of claim 20, wherein the physical characteristics include one or more characteristics selected from the group consisting of:
number of processor cores;
number of cores per processor;
system bus speed;
maximum cache size; and
processor clock speed.

23. A computer-storage medium storing computer-executable instructions that, when executed on a computing system, cause the computing system to:
calculate an estimated throughput for a target computing system using a predetermined model based on physical characteristics of the target computing system; and
determine an estimated utilization of the target computing system based on a utilization of a source computing system and a ratio of throughput of the source computing system to the estimated throughput of the target computing system.

24. The computer-storage medium of claim 23, wherein calculating an estimated throughput for a first computing system includes calculating a product of values derived from the physical characteristics of the first computing system.

25. The computer-storage medium of claim 23, wherein the physical characteristics include one or more characteristics selected from the group consisting of number of processor cores;
number of cores per processor;
system bus speed;
maximum cache size; and
processor clock speed.

26. A method of estimating performance of a computing system, the method comprising:
deriving a model of computing system performance that is a product of powers of physical characteristics of a computing system and derived from physical characteristics and measured performance of a plurality of computing systems having analogous system architectures; and
obtaining an estimated performance of a computing system based on the model and the physical characteristics of the computing system.

27. The method of claim 26, wherein the computing system and the plurality of computing systems use a common instruction set architecture.
